(19) United States
(12) Patent Application Publication
(10) Pub. No.: US 2006/0191009 A1
(43) Pub. Date: Aug. 24, 2006

(54) Data encryption/decryption method and monitoring system

(75) Inventors: Kazuyuki Ito, Tokyo (JP); Kazunori Miyazawa, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/301,380

(22) Filed: Dec. 12, 2005

(30) Foreign Application Priority Data
Dec. 14, 2004 (JP) P.2004-360821

(51) Int. Cl. G06F 12/14

(52) U.S. Cl. 726/23

(57) ABSTRACT

A monitoring system has a distribution apparatus which encrypts continuous data and distributes the encrypted continuous data via a network, a reproduction apparatus which decrypts the encrypted data distributed via the network to reproduce the continuous data, and a key management apparatus which has a key management database. The distribution apparatus obtains a key number correlated with the distribution apparatus and key information correlated with the key number from the key management apparatus, encrypts data with using the obtained key information, and distributes the encrypted data with the obtained key number. The reproduction apparatus transmits the key number appended to the encrypted data to the key management apparatus, obtains key information correlated with the transmitted key number, and decrypts the encrypted data with using the obtained key information.

### CROSS-REFERENCE TO RELATED APPLICATIONS

This application is based upon and claims the benefit of priority from the prior Japanese Patent Applications No. 2004-360821, filed on Dec. 14, 2004, the entire contents of which are incorporated herein by reference.

### BACKGROUND OF THE INVENTION

1. Field of the Invention

The invention relates to a data encryption/decryption method and a monitoring system. The invention particularly relates to the improvement of a key management method under a system where an apparatus distributing continuous data such as for moving images differs from a key management apparatus managing keys used for encryption and decryption to provide security for the continuous data.

In order to realize security for continuous data, it is required that keys for encrypting and decrypting data are changed in accordance with appropriate timings.

2. Description of the Related Art

There is a system as a related art wherein an image distribution apparatus that has a plurality of image distribution units, such as surveillance cameras, positioned in a monitored area, transmits image data via a network to an image reproduction apparatus, and the image reproduction apparatus reproduces and displays the received image data.

JP-A-2004-274478 discloses a system wherein an image distribution apparatus encrypts image data to be distributed, and an image reproduction apparatus decrypts the image data to reproduce the decrypted image data.

JP-A-2004-274478 (Page 3, Paragraph [0005]) is referred to as a related art.

FIG. 5 is a block diagram showing an example configuration for an example monitoring system as a related art. This system has an image distribution apparatus 10 which is located in a monitored area and includes a plurality of image distribution units 11 (for example, surveillance cameras) generating continuous image data such as moving images, an image reproduction apparatus 30 which reproduces image data received from the image distribution apparatus 10 via a network 20, and a key management apparatus 40 which manages keys used for encryption and decryption to realize security for the continuous data.

In order to realize the security for the continuous data, the monitoring system manages keys for the continuous data, such as time stamps for data or sequence numbers. The key management process will now be described in detail.

(1) Management of Keys Relative to Time

The image distribution apparatus 10 for generating data obtains from the key management apparatus 40, via a network 20a, a key designated for use at a specific time or for a specified period of time, or transmits the designated key to the key management apparatus 40 via the network 20a. The image distribution apparatus 10 employs the designated key to encrypt data, or when data are to be decrypted by the image reproduction apparatus 30, the image distribution apparatus 10 obtains the designated key, for the relative time, from the key management apparatus 40, via the network 20a, to decrypt the data.

(2) Management of Keys Relative to Sequence Numbers

The image distribution apparatus 10, for generating data, obtains from the key management apparatus 40, via the network 20a, a designated key for a relative sequence number, or transmits the key to the key management apparatus 40.

The image distribution apparatus 10 employs the designated key to encrypt data, or when the image reproduction apparatus 30 is to decrypt data, the image distribution apparatus 10 obtains the designated key, for the relative sequence number, from the key management apparatus 40, via the network 20a, to decrypt the data.

However, when the monitoring system as a related art is employed, the following problems are encountered.

In the case (1) that management of the keys is performed relative to time, when the key management apparatus 40 which manages and provides a key is different from the apparatus (the image distribution apparatus 10 or the image reproduction apparatus 30) which uses the key, time synchronization between the two apparatuses is required.

However, it is difficult to obtain exact time synchronization, and the costs involved are increased. Further, when the reversal of time occurs while the time for the image distribution apparatus 10 is being shifted, the key management can not be correctly performed.

In the case (2) that management of the keys is performed relative to sequence numbers, when the sequence numbers overlap for some reason such as reset, it is difficult to correctly perform the key management.

### SUMMARY OF THE INVENTION

An object of the invention is to provide a data encryption/decryption method and a monitoring system which has a key management apparatus managing keys, an apparatus encrypting continuous data, and an apparatus reproducing decrypting data, in which key data in the database of the key management apparatus can be appropriately used for encrypting and decrypting distributed data while maintaining high security, and management of the keys is also performed easily.

The invention provides a data encryption/decryption method performed in a monitoring system including a distribution apparatus which encrypts continuous data and distributes the encrypted continuous data via a network, a reproduction apparatus which decrypts the encrypted data distributed via the network to reproduce the continuous data, and a key management apparatus which has a key management database, wherein the distribution apparatus obtains a key number correlated with the distribution apparatus and key information correlated with the key number from the key management apparatus, encrypts data with using the obtained key information, and distributes the encrypted data with the obtained key number, and the reproduction apparatus transmits the key number appended to the encrypted data to the key management apparatus, obtains key information correlated with the transmitted key number, and decrypts the encrypted data with using the obtained key information.

According to the data encryption/decryption method, since the key management apparatus provided separately from the distribution apparatus and the reproduction apparatus can manage keys, key management is easy. Furthermore, key data managed by the key management apparatus can be effectively used for the encryption and decryption of distributed data while high security is maintained.

The invention also provides a monitoring system, having: a distribution apparatus which encrypts continuous data and distributes the encrypted continuous data via a network; a reproduction apparatus which decrypts the encrypted data distributed via the network to reproduce the continuous data; and a key management apparatus which has a key management database, wherein the distribution apparatus obtains a key number correlated with the distribution apparatus and key information correlated with the key number from the key management apparatus, encrypts data with using the obtained key information, and distributes the encrypted data with the obtained key number, and the reproduction apparatus transmits the key number appended to the encrypted data to the key management apparatus, obtains key information correlated with the transmitted key number, and decrypts the encrypted data with using the obtained key information.

According to the monitoring system, the encryption and decryption performed while maintaining high security can also be performed by the effective use of key data managed by the key management apparatus. The key management process is also easy.

In the monitoring system, the continuous data is at least one of image data, audio data, or measurement data obtained from a sensor provided in the monitoring system.

In the monitoring system, the key management database includes a key management database stores key numbers and key information which are correlated with each other, and an identification number used for identifying the distribution apparatus and a key number currently being used by the distribution apparatus which are correlated with each other.

According to the data encryption/decryption method and the monitoring system, since the encryption and decryption of distribution data is performed by effectively using the key information managed by the key management apparatus, high security is easily provided for encryption and decryption.

The key management process provided by the key management apparatus, while using the key management database, is extremely simple and easy to perform.

Furthermore, when the apparatus which uses a key to encrypt continuous data differs from the apparatus which manages the key, the key management process is also simple. And neither the time synchronization process, which is performed by the system as a related art and for which a cost is incurred, nor the storage of the sequence number, which is performed when the apparatus that generates data is reset, is required.

### BRIEF DESCRIPTION OF THE DRAWINGS

FIG. 1 is a block diagram showing an embodiment of a monitoring system according to the invention;

FIG. 2 is a diagram showing an example key management table in a key management database;

FIG. 3 is a diagram showing an example apparatus management table in the key management database;

FIG. 4 is a block diagram showing another embodiment of a monitoring system according to the invention; and

FIG. 5 is a block diagram showing the configuration of an example monitoring system as a related art.

### DETAILED DESCRIPTION OF THE PREFERRED EMBODIMENTS

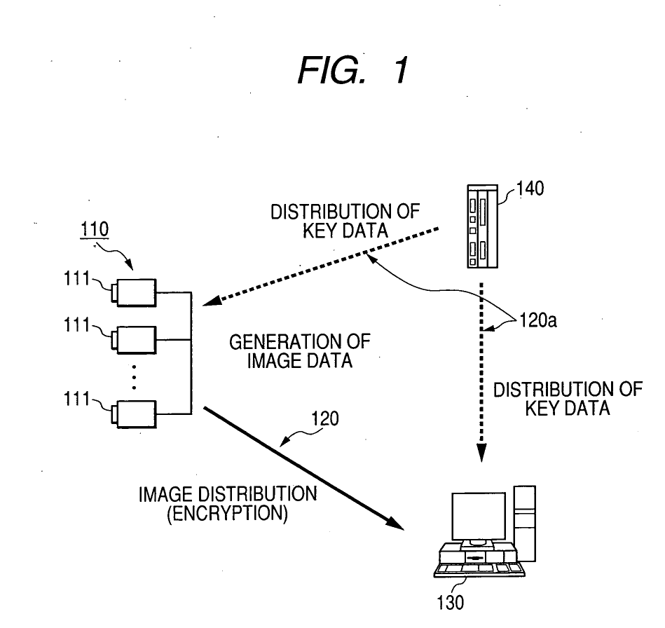

Embodiments of the invention will now be described in detail with reference to the drawings. A data encryption/decryption method and a monitoring system will be described. In an embodiment, image data obtained by a surveillance camera is used. FIG. 1 shows an embodiment of a monitoring system according to the invention.

The monitoring system shown in FIG. 1 has an image distribution apparatus 110 including image distribution units 111 such as surveillance cameras, an image reproduction apparatus 130, and a key management apparatus 140. In the embodiment, the image distribution apparatus 110 distributes encrypted image data to the image reproduction apparatus 130 via a network 120. Therefore, the communication path need not be secured, using IPsec or SSL, in order to keep the image data secure.

On the other hand, key information is transmitted in the directions indicated by broken-line arrows via a network 120a between the key management apparatus 140 and the image distribution apparatus 110, and between the key management apparatus 140 and the image reproduction apparatus 130. In the embodiment, secure communication using IPsec or SSL is requisite between the key management apparatus 140 and the image distribution apparatus 110, and between the key management apparatus 140 and the image reproduction apparatus 130.

The operation of each apparatus in the monitoring system will be explained below.

(1) The key management apparatus 140 has a key management database and searches the key management database for the latest key number used by the image distribution apparatus 110 and the key information correlated with the latest key number. The key management apparatus 140 transmits the key number and the key information to the image distribution apparatus 110.

(2) The image distribution apparatus 110 generates continuous data, encrypts the generated image data by using the key information correlated with the obtained key number, and distributes the encrypted image data to which the key number is appended.

(3) The image reproduction apparatus 130 obtains the key number from the received image data, and transmits the key number to the key management apparatus 140 and requests correlated key information.

(4) The key management apparatus 140 transmits the correlated key information for the key number to the image reproduction apparatus 130.

(5) The image reproduction apparatus 130 uses the obtained key information to decrypt the encrypted, distributed image data, and displays the decrypted image data.

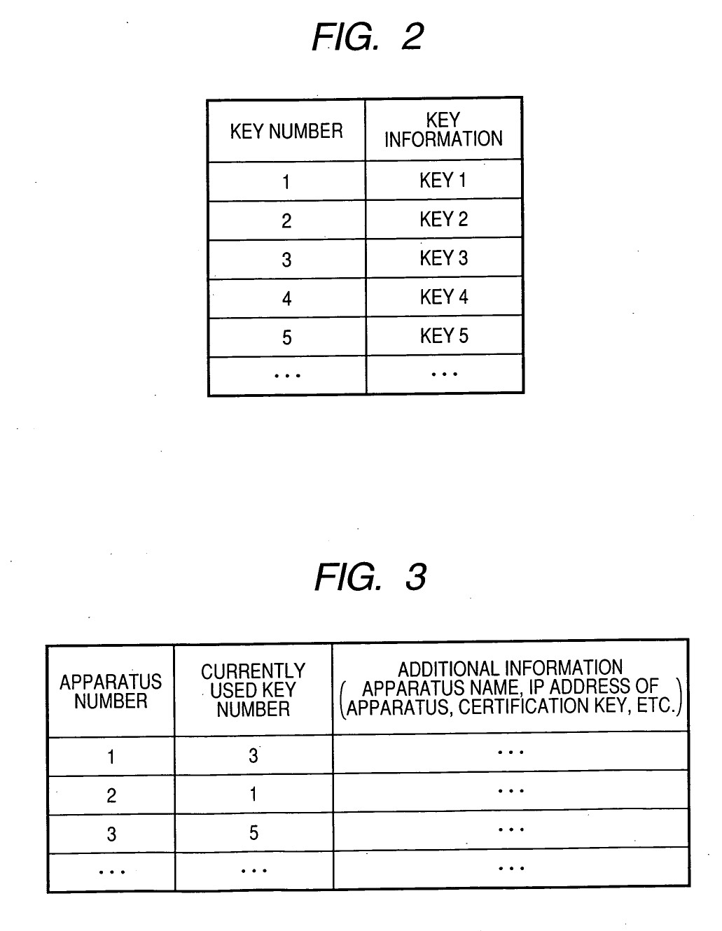

The key management database will now be explained in detail. A key management table shown in FIG. 2 and an apparatus management table shown in FIG. 3 are stored in the key management database (e.g., a relational database) held by the key management apparatus 140.

The key management table is a management table which stores key numbers to be used by the image distribution apparatus 110 and the image reproduction apparatus 130 and key information correlated with the key numbers As shown in FIG. 2, key numbers (1, 2, 3, . . . ) and key information (Key1, Key2, Key3, . . . ) are correlated with each other. The main key is the key numbers.

The apparatus management table is a table which manages information of the image distribution apparatus 110. As shown in FIG. 3, the apparatus management table stores apparatus numbers (1, 2, 3, . . . ), currently used key numbers (e.g., 3, 1, 2, . . . ), and additional information (e.g., apparatus name, IP address of apparatus or certification key, etc.), which are correlated with each other. In this case, the main key is the apparatus numbers. The apparatus number is an identification number used to uniquely identify the image distribution apparatus 110.

The currently used key number is a key number that the image distribution apparatus 110 is currently using. Correlated key information can be obtained from the key management table shown in FIG. 2.

The additional information defines the apparatus name, the IP address of the apparatus, or the certification key, etc., as needed. The certification key becomes effective when the image distribution apparatus 110 is installed on the Internet and an access certification is obtained as a measure used to prevent a DOS attack.

By using the key management database in FIGS. 2 and 3, the key management apparatus 140 provides the key numbers and key information which are used by the image distribution apparatus 110 for image data encryption and by the image reproduction apparatus 130 for image data decryption.

The image distribution sequence (the data encryption/decryption method) is performed by the image distribution apparatus 110 as follows.

(Activation Time)

(1) The image distribution apparatus 10 requests a key number and key information from the key management apparatus 140.

(2) The key management apparatus 140 searches the key management database for the latest key number used by the image distribution apparatus 110 and correlated key information, and transmits the key number and the key information to the image distribution apparatus 110.

(3) The image distribution apparatus 110 encrypts image data using the received key information, and shifts the operating state to the image distribution enabled state.

(Image Distribution Enabled State)

(4) The image distribution apparatus 110 receives an image distribution request from the image reproduction apparatus 130.

(5) The image distribution apparatus 110 encrypts image data by using key information previously obtained from the key management apparatus 140, and transmits to the image reproduction apparatus 130 the encrypted image data, to which the key number is appended.

The image reproduction sequence is performed by the image reproduction apparatus 130 as follows.

(1) The image reproduction apparatus 130 obtains, from the image distribution apparatus 110, desired image data to be reproduced.

(2) The image data obtained includes a key number and encrypted image data. The image reproduction apparatus 130 transmits the key number to the key management apparatus 140 and obtains correlated key information.

(3) The image reproduction apparatus 130 decrypts the encrypted image data, using the obtained key information, and reproduces the plaintext image data.

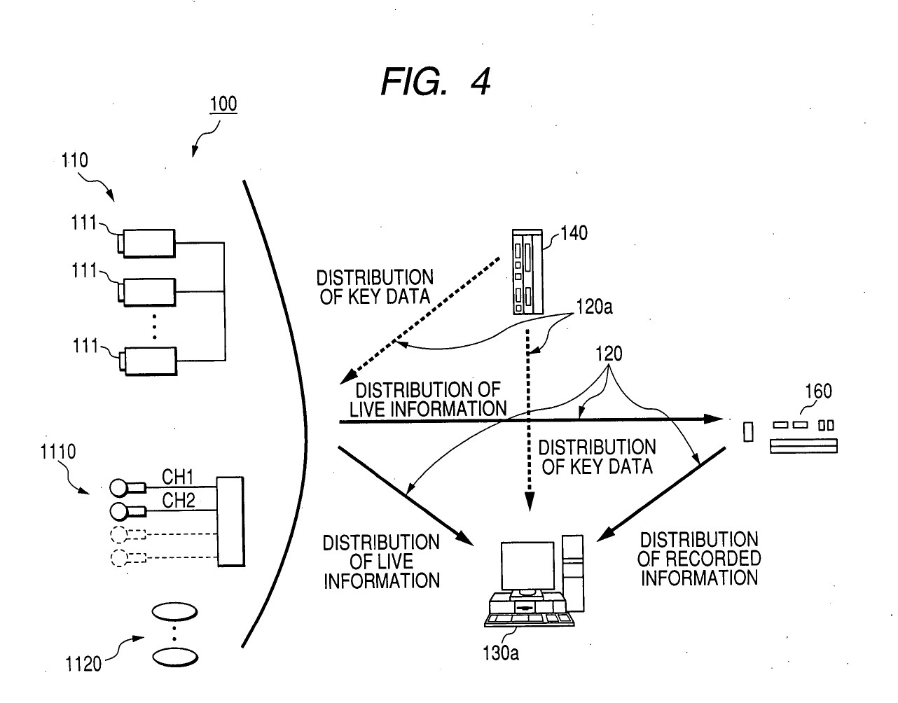

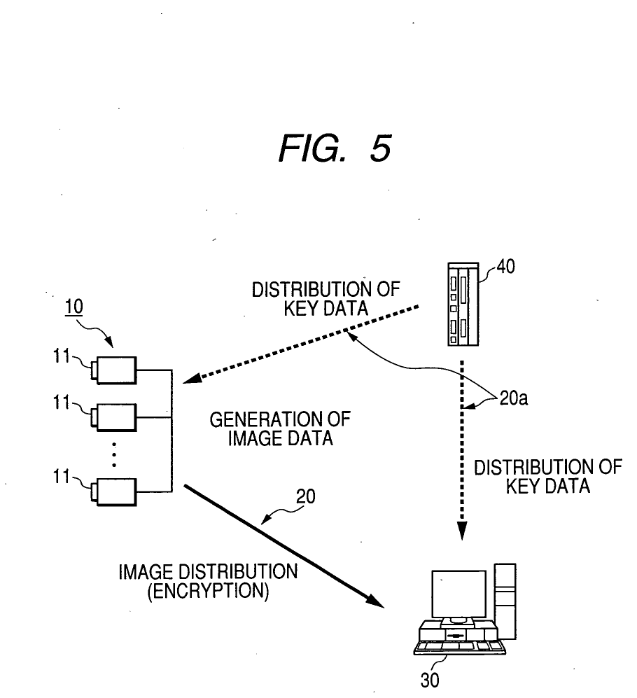

Although image data have been used as an example in the above embodiment, the invention is not limited to image data. The invention can be applied for a case wherein an apparatus that generates continuous data differs from a key management apparatus that manages keys for encrypting and decrypting data, and can be used, for example, for a camera monitoring system shown in FIG. 4.

In FIG. 4, an information distribution apparatus 100 that distributes data has the image distribution apparatus 110 in the embodiment, an audio distribution apparatus 1110 for multiple channels (CH1, CH2, . . . ), and multiple information distribution apparatuses 1120 such as sensors.

Various types of live information output by the information distribution apparatus 100 are distributed to a data reproduction/display apparatus 130a or to a recording apparatus 160.

When the live information is distributed to the data reproduction/display apparatus 130a, the information is encrypted or decrypted in the same manner as described in the embodiment.

When the live information is to be distributed to the recording apparatus 160, the following process is performed. As well as in the embodiment, the information distribution apparatus 100 encrypts the live information using the key information, and distributes the encrypted live information to the recording apparatus 160, with a key number appended. The recording apparatus 160 then records the encrypted live information.

The data reproduction/display apparatus 130a obtains, from the recording apparatus 160, data for which reproduction is desired. The data thus obtained includes the key number and the encrypted data. Thereafter, the data reproduction/display apparatus 130a obtains, from the key management apparatus 140, key information related to the key number, uses the thus obtained key information to decrypt the encrypted data and reproduces/displays the decrypted data.

The present invention is not limited to the embodiment, and further alterations and modifications can be included without departing from the essence of the invention.

What is claimed is:

1. A data encryption/decryption method performed in a monitoring system including a distribution apparatus which encrypts continuous data and distributes the encrypted continuous data via a network, a reproduction apparatus which decrypts the encrypted data distributed via the network to reproduce the continuous data, and a key management apparatus which has a key management database,
wherein the distribution apparatus obtains a key number correlated with the distribution apparatus and key information correlated with the key number from the key management apparatus, encrypts data with using the obtained key information, and distributes the encrypted data with the obtained key number, and
the reproduction apparatus transmits the key number appended to the encrypted data to the key management apparatus, obtains key information correlated with the transmitted key number, and decrypts the encrypted data with using the obtained key information.

2. A monitoring system, comprising:
a distribution apparatus which encrypts continuous data and distributes the encrypted continuous data via a network;
a reproduction apparatus which decrypts the encrypted data distributed via the network to reproduce the continuous data; and
a key management apparatus which has a key management database,
wherein the distribution apparatus obtains a key number correlated with the distribution apparatus and key information correlated with the key number from the key management apparatus, encrypts data with using the obtained key information, and distributes the encrypted data with the obtained key number, and
the reproduction apparatus transmits the key number appended to the encrypted data to the key management apparatus, obtains key information correlated with the transmitted key number, and decrypts the encrypted data with using the obtained key information.

3. The monitoring system according to claim 2,
wherein the continuous data is at least one of image data, audio data, or measurement data obtained from a sensor provided in the monitoring system.

4. The monitoring system according to claim 2,
wherein the key management database includes a key management database stores key numbers and key information which are correlated with each other, and an identification number used for identifying the distribution apparatus and a key number currently being used by the distribution apparatus which are correlated with each other.
